(19) United States
(12) Patent Application Publication
(10) Pub. No.: US 2023/0023126 A1
(43) Pub. Date: Jan. 26, 2023

(54) PARTIAL SUPERVISION IN SELF-SUPERVISED MONOCULAR DEPTH ESTIMATION

(71) Applicant: QUALCOMM Incorporated, San Diego, CA (US)

(72) Inventors: Amin ANSARI, Federal Way, WA (US); Avdhut JOSHI, San Marcos, CA (US); Gautam SACHDEVA, San Diego, CA (US); Ahmed Kamel SADEX, San Diego, CA (US)

(21) Appl. No.: 17/812,340

(22) Filed: Jul. 13, 2022

Related U.S. Application Data
(60) Provisional application No. 63/221,856, filed on Jul. 14, 2021.

(51) Int. Cl. G06T 7/521; G06T 7/70

(52) U.S. Cl. CPC G06T 7/521; G06T 7/70; G06T 2207/20081; G06T 2207/10028

(57) ABSTRACT

Certain aspects of the present disclosure provide techniques for machine learning. A depth output from a depth model is generated based on an input image frame. A depth loss for the depth model is determined based on the depth output and an estimated ground truth for the input image frame, the estimated ground truth comprising estimated depths for a set of pixels of the input image frame. A total loss for the depth model is determined based at least in part on the depth loss. The depth model is updated based on the total loss, and a new depth output, generated using the updated depth model, is output.

### CROSS-REFERENCE TO RELATED APPLICATIONS

This application claims benefit of and priority to U.S. Provisional Patent Application Ser. No. 63/221,856, filed Jul. 14, 2021, which is herein incorporated by reference in its entirety.

### INTRODUCTION

Aspects of the present disclosure relate to machine learning.

Machine learning has revolutionized many aspects of computer vision. Yet, estimating the depth of an object in image data remains a challenging computer vision task relevant to many useful ends. For example, depth estimation based on computer-generated image data is useful in autonomous and semi-autonomous systems, such as self-driving automobiles and semi-autonomous drones, to perceive and navigate environments and to estimate state.

Training machine learning models for depth estimation is generally performed using supervised machine learning techniques, which require significant amounts of well-prepared training data (e.g., training data with accurate distance labels at a pixel level for image data). Unfortunately, in many real world applications, such data is generally not readily available and is difficult to acquire. Thus, it is difficult, if not impossible in practice, to train high-performance models for depth estimation in many contexts.

Accordingly, there is a need for improved machine learning techniques for depth estimation.

### BRIEF SUMMARY

Certain aspects provide a method, including generating a depth output from a depth model based on an input image frame; determining a depth loss for the depth model based on the depth output and a partial estimated ground truth for the input image frame, the partial estimated ground truth comprising estimated depths for only a subset of a plurality of pixels of the input image frame; determining a total loss for the depth model using a multi-component loss function, wherein at least one component of the multi-component loss function is the depth loss; and updating the depth model based on the total loss.

Certain aspects provide a method, including generating a depth output from a depth model based on an input image frame; determining a depth loss for the depth model based on the depth output and an estimated ground truth for the input image frame, the estimated ground truth comprising estimated depths for a set of pixels of the input image frame; determining a total loss for the depth model based at least in part on the depth loss; updating the depth model based on the total loss; and outputting a new depth output generated using the updated depth model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example of a monocular depth estimation with a resulting “hole” in the depth map.

FIG. 2 depicts an example training architecture for partial supervision in self-supervised monocular depth estimation.

FIG. 3 depicts example bounding polygons representing objects that are being tracked by an active depth sensing system.

FIG. 4 depicts an example of a method for using partial supervision in self-supervised monocular depth estimation according to aspects of the present disclosure.

FIG. 5 depicts an example of processing system adapted to perform operations for the techniques disclosed herein, such as the operations depicted and described with respect to FIG. 4.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for performing partial supervision in self-supervised monocular depth estimation.

Estimating depth information in image data is an important task in computer vision applications, which can be used in simultaneous localization and mapping (SLAM), navigation, object detection, and semantic segmentation, to name just a few examples. For example, depth estimation is useful for obstacle avoidance (e.g., for drones flying (semi-)autonomously, cars driving (semi-)autonomously or with assistance, warehouse robots operating (semi-)autonomously, household and other robots generally moving (semi-)autonomously, 3D construction of an environment, spatial scene understanding, and other examples.

Traditionally, depth has be estimated using binocular (or stereo) image sensor arrangements and based on calculating the disparity between corresponding pixels in different binocular images. For example, in simple cases, depth d may be calculated between corresponding points as follows:

$$d = ( \frac{b * f}{δ} ) ,$$

where b is the baseline distance between the image sensors, f is the focal length of the image sensors, and δ is the disparity between the points, as depicted in each of the images. However, in cases in which there is only one perspective, such as a single image sensor, traditional stereoscopic methods cannot be used. Such cases may be referred to as monocular depth estimation.

Direct depth sensing based methods may also be used to provide depth information. For example, red, green, blue, and depth (RGB-D) cameras and light detection and ranging (LIDAR) sensors may be used to estimate depth directly. However, RGB-D cameras generally suffer from limited measurement range and bright light sensitivity, and LIDAR can generally only generate sparse 3D depth maps, which are of much lower resolutions than any corresponding image data. Further, the large size and power consumption of such sensing systems make them undesirable for many applications, such as drones, robots, and even automobiles. By contrast, monocular image sensors tend to be low cost, small in size, and low power, which makes such sensors desirable in a wide variety of applications.

Monocular depth estimation has proven challenging in conventional solutions, as neither the well-understood math of binocular depth estimation nor direct sensing can be used in such scenarios. Nevertheless, deep learning-based methods have been developed for performing depth estimation in a monocular context. For example, structure from motion (SfM) techniques have been developed to determine the depth of objects in monocular image data based on analyzing how features move across a series of images. However, depth estimation using SfM is heavily reliant on feature correspondences and geometric constraints between image sequences. In other words, the accuracy of depth estimation using SfM relies heavily on exact feature matching and high-quality image sequences.

A fundamental challenge with existing monocular depth estimation techniques, such as SfM, is the assumption that the world and/or scenery, around the object for which depth is to be estimated, is static. In reality, objects in the scenery are often moving as well, and often in uncorrelated and different directions, at different speeds, and the like. For example, in the self-driving context, other vehicles on the road are moving independently of a vehicle being tracked by an assisted or autonomous driving system, and thus an important segment of the scenery is not static. This is especially problematic when a tracked object moves close to and/or at a similar speed as the tracking vehicle, which is a prevalent circumstance in highway driving scenarios.

A consequence of the sensed environment violating the assumptions underlying conventional depth estimation models is the generation or appearance of so-called “holes” in the depth estimation data, such as a hole in a depth sensing map. While some conventional approaches, such as motion modeling (where the scene and object being tracked are modeled separately) and explainability masking (which tries to mask out pixels associated with moving objects in the scenery), have attempted to deal with these issues, each has substantial drawbacks. For example, given the underlying complexity of the loss function(s) used for motion modeling, such techniques require significant numbers of training frames/images to have reasonable accuracy. Even then, motion modeling does not perform well for moving objects in the scenery. Similarly, explainability masking is generally only effective if similar scenes have been observed during training, and do not work well for new scenes, which is a common occurrence with driving.

Further, SfM, like other monocular depth estimation methods, suffers from monocular scale ambiguity, which is the problem of not being able to determine the scale of an object even when its distance is known. Thus, obtaining a dense depth map from a single image is still a significant challenge in the art.

Beneficially, aspects described herein eliminate the need for large, curated ground-truth datasets, and instead rely on estimated ground-truth data for model training using self-supervision. This enables training of a wider variety of models for a wider variety of tasks without the limitations of existing datasets.

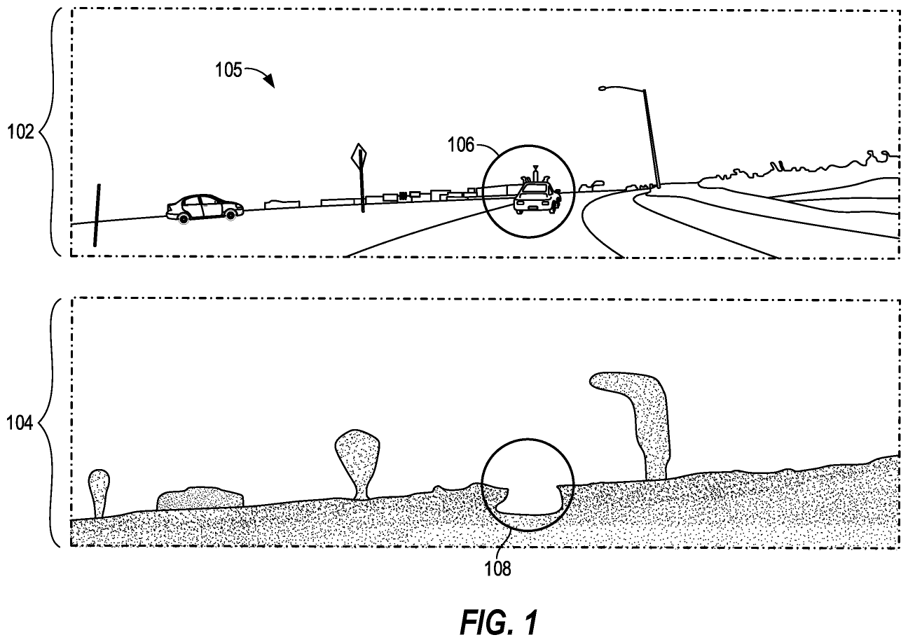

Moreover, aspects described herein overcome limitations of conventional depth estimation techniques by generating additional supervisory signals related to objects that are not static in the scenery. This overcomes a critical limitation of conventional methods, such as SfM, which assume objects in a scene are static and only move relative to a dynamic observer. Thus, methods described herein overcome a tendency of SfM and similar methods to fail to estimate a depth of an object that lacks relative motion compared to an observer over a sequence of images. For example, where a first vehicle is following a second vehicle at the same or similar speed, SfM may fail to predict a depth of the second vehicle because it is completely static or nearly-static, relative to the observer (here, the first vehicle), as described with respect to the example in FIG. 1. This is an important problem for a wide variety of solution spaces, such as self-driving cars, as well as other navigational and similar use cases, such as with drones, robots, and the like. Although some examples discussed herein relate to monocular depth estimation for self-driving vehicles or other moving objects, aspects of the present disclosure can be readily applied to stationary imaging as well.

Finally, some aspects described herein may beneficially use sensor fusion to resolve the scale ambiguity problem associated with conventional monocular depth estimation techniques.

Accordingly, aspects described herein provide improved training techniques for generating improved monocular depth estimation models compared to conventional techniques.

### Example Monocular Depth Map Hole

FIG. 1 depicts an example of a monocular depth estimation with a resulting “hole” in the depth map. In particular, image 102 depicts a driving scene in which an observer is following a vehicle 106. Depth map 104 depicts estimated depths of objects in the scene in image 102, where different depths are indicated by different pixel shades.

Notably, vehicle 106 is an object of obvious interest for assisted driving systems, such active cruise control systems and other navigational aids. However, depth map 104 has a “hole” 108, indicated using a circle in the illustrated example, corresponding to the location of vehicle 106. This is because vehicle 106 is moving at nearly the same speed as the observing (or “ego”) vehicle, and thus violates the assumption of a static scenery. Much like the sky 105 in image 102, vehicle 106 appears to be an indeterminate distance away in the depth map 104.

### Example Training Architecture for Partial Supervision in Self-Supervised Monocular Depth Estimation

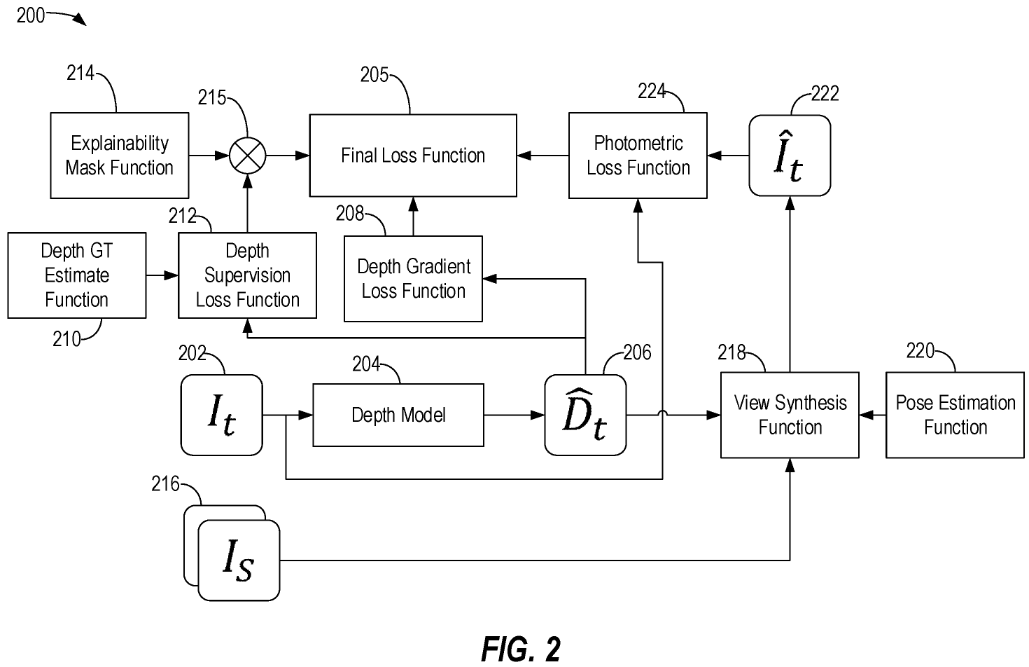

FIG. 2 depicts an example training architecture 200 for partial supervision in self-supervised monocular depth estimation.

Initially, a subject frame of image data at time t (Iₜ) 202 is provided to a machine learning depth model 204, such as a monocular depth-estimating artificial neural network model (referred to in some examples as “DepthNet”). Depth model 204 processes the image data and generates an estimated depth output (\hat{D}ₜ) 206. The estimated depth output 206 can take different forms, such as a depth map indicating the estimated depth of each pixel directly, or a disparity map indicating the disparity between pixels. As discussed above, depth and disparity are related and can be proportionally derived from each other.

The estimated depth output 206 is provided to a depth gradient loss function 208, which determines a loss based on, for example, the “smoothness” of the depth output. In one aspect, the smoothness of the depth output may be measured by the gradients (or average gradient) between adjacent pixels across the image. For example, an image of a simple scene having few objects may have a very smooth depth map, whereas an image of a complex scene with many objects may have a less smooth depth map, as the gradient between depths of adjacent pixels changes frequently and significantly to reflect the many objects.

Depth gradient loss function 208 provides a depth gradient loss component to final loss function 205. Though not depicted in the figure, the depth gradient loss component may be associated with a hyperparameter (e.g., a weight) in final loss function 205, which changes the influence of the depth gradient loss on final loss function 205.

The estimated depth output 206 is also provided as an input to view synthesis function 218. View synthesis function 218 further takes as inputs one or more context frames (I_{S}) 216 and a pose estimate from pose estimation function 220 and generates a reconstructed subject frame ( [symbol] ) 222. For example, view synthesis function 218 may perform an interpolation, such as bilinear interpolation, based on a pose projection from pose estimation function 220 and using the depth output 206.

The context frames 216 may generally comprise frames near to the subject frame 202. For example, context frames 216 may be some number of frames or time steps on either side of subject frame 202, such as t+/−1 (adjacent frames), t+/−2 (non-adjacent frames), or the like. Though these examples are symmetric about subject frame 202, context frames 216 could be non-symmetrically located, such as t−1 and t+3.

Pose estimation function 220 is generally configured to perform pose estimation, which may include determining a projection from one frame to another. The pose estimation function 220 can use any suitable techniques or operations to generate the pose estimates, such as using a trained machine learning model (e.g., a pose network). In an aspect, the pose estimate (also referred to as a relative pose or relative pose estimate in some aspects) generally indicates the (predicted) pose of objects, relative to the imaging sensor (e.g., relative to the ego vehicle). For example, the relative pose may indicate the inferred location and orientation of objects relative to the ego vehicle (or the location and orientation of the imaging sensor relative to one or more object(s)).

Reconstructed subject frame 222 may be compared against subject frame 202 by a photometric loss function 224 to generate a photometric loss, which is another component of final loss function 205. As discussed above, though not depicted in the figure, the photometric loss component may be associated with a hyperparameter (e.g., a weight) in final loss function 205, which changes the influence of the photometric loss on final loss function 205.

The estimated depth output 206 is additionally provided to depth supervision loss function 212, which takes as a further input estimated depth ground truth values for subject frame 202, generated by depth ground truth estimate function 210, in order to generate a depth supervision loss. In some aspects, depth supervision loss function 212 only has or uses estimated depth ground truth values for a portion of the scene in subject frame 202, thus this step may be referred to as a “partial supervision”. In other words, while depth model 204 provides a depth output for each pixel in subject frame 202, depth ground truth estimate function 210 may only provide estimated ground truth values for a subset of the pixels in subject frame 202.

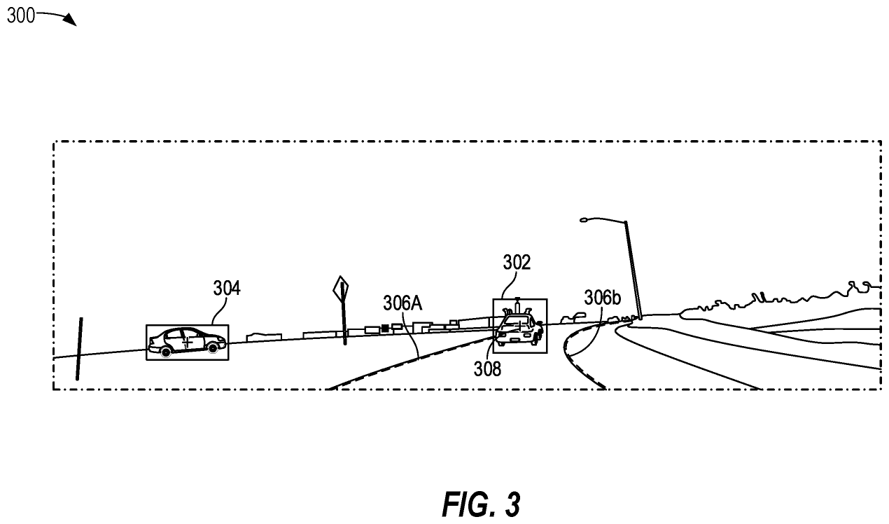

Depth ground truth estimate function 210 may generate estimated depth ground truth values by various different methods. In one aspect, the depth ground truth estimate function 210 comprises a sensor fusion function (or module) that uses one or more sensors to directly sense depth information from the scene/environment corresponding to all or a portion of subject frame 202. For example, FIG. 3 depicts an image 300 with bounding polygons 302 and 304 (bounding squares (or “boxes”) in this example) representing objects that are being tracked by an active depth sensing system, such as LIDAR and/or radar. Additionally, FIG. 3 depicts other features, such as street/lane lines or markers 306A and 306B, which may be determined by a camera sensor (e.g., using computer vision techniques). Thus, in this example, the data is being fused from image sensors as well as other sensors, such as LIDAR and radar.

In some aspects, the center of a bounding polygon (e.g., indicated by the crosshair at point 308 of bounding polygon 302) may be used as a reference for estimated depth information. For example, in a simple case, all of the pixels inside the bounding polygon may be estimated as the same depth value as the center pixel. Since this is an approximation, the loss term generated by the depth supervision loss function 212 may have a relatively smaller weight compared to the other terms constructing the final loss function 205.

In another example, a more sophisticated model for estimating depth within the bounding polygon may be used, such as estimating the depth-per-pixel in the bounding polygon based on a 3D model of an object determined to be in the bounding polygon. For example, the 3D model could be of a type of vehicle, such as a car, small truck, large truck, SUV, tractor trailer, bus, and the like. Thus, different pixel depths may be generated with reference to a 3D model, and in some cases an estimated pose of the object based on the 3D model.

In yet another example, the depth of pixels in the bounding polygon may be modeled based on distance from a central pixel (e.g., distance of pixels in bounding polygon 302 (e.g., a bounding square) from a central pixel at point 308). For example, the depth may be assumed to be related by a Gaussian function based on distance from the central pixel, or using other functions.

Returning to FIG. 2, the depth supervision loss generated by depth supervision loss function 212 may be masked (using mask operation 215) based on an explainability mask provided by explainability mask function 214. The purpose of the explainability mask is to limit the impact of the depth supervision loss to those pixels in subject frame 202 that do not have explainable (e.g., estimable) depth.

For example, a pixel in subject frame 202 may be marked as “non-explainable” if the reprojection error for that pixel in the warped image (estimated subject frame 222) is higher than the value of the loss for the same pixel with respect to the original (unwarped) context frame 216. In this example, “warping” refers to the view synthesis operation performed by view synthesis function 218. In other words, if no associated pixel can be found with respect to the original subject frame 202 for the given pixel in the reconstructed subject frame 222, then the given pixel was probably globally non-static (or relatively static to the camera) in the subject frame 202 and therefore cannot be reasonably explained.

The depth supervision loss generated by depth supervision loss function 212 and as modified/masked by the explainability mask produced by explainability mask function 214 is provided as another component to final loss function 205. As above, though not depicted in the figure, the depth supervision loss component (output from mask operation 215) may be associated with a hyperparameter (e.g., a weight) in final loss function 205, which changes the influence of the depth supervision loss on final loss function 205.

Accordingly, depth groundtruth estimate function 210, depth supervision loss function 212, and explainability mask function 214 provide an additional (and in some cases partial) supervisory signal that allows improved training of self-supervised monocular depth estimation models (e.g., depth model 204).

In an aspect, the final or total (multi-component) loss generated by the final loss function 205 (which may be generated based a depth gradient loss generated by a depth gradient loss function 208, a (masked) depth supervision loss generated by the depth supervision loss function 212, and/or a photometric loss generated by the photometric loss function 224) is used to update or refine the depth model 204. For example, using gradient descent and/or backpropagation, one or more parameters of the depth model 204 may be refined or updated based on the total loss generated for a given subject frame 202.

In aspects, this updating may be performed independently and/or sequentially for a set of subject frames 202 (e.g., using stochastic gradient descent to sequentially update the parameters of the depth model 204 based on each subject frame 202) and/or in based on batches of subject frames 202 (e.g., using batch gradient descent).

Using the training architecture 200, the depth model 204 thereby learns to generate improved and more-accurate depth estimations (e.g., depth output 206). During runtime inferencing, the trained depth model 204 may be used to generate depth output 206 for an input subject frame 202. This depth output 206 can then be used for a variety of purposes, such as autonomous driving and/or driving assistance, as discussed above. In some aspects, at runtime, the depth model 204 may be used without consideration or use of other aspects of the training architecture 200, such as the context frame(s) 216, view synthesis function 218, pose estimation function 220, reconstructed subject frame 222, photometric loss function 224, depth gradient loss function 208, depth ground truth estimate function 210, depth supervision loss function 212, explainability mask function 214, and/or final loss function 205.

In at least one aspect, during runtime, a monocular depth model (e.g., the depth model 204) may be continuously or repeatedly used to process input frames. Intermittently, the self-supervised training architecture 200 may be activated to refine or update the depth model 204. In some aspects, this intermittent use of the training architecture 200 to update the depth model 204 may be triggered by various events or dynamic conditions, such as in accordance with a predetermined schedule, and/or in response to performance deterioration, presence of an unusual environment or scene, availability of computing resources, and the like.

### Example Method

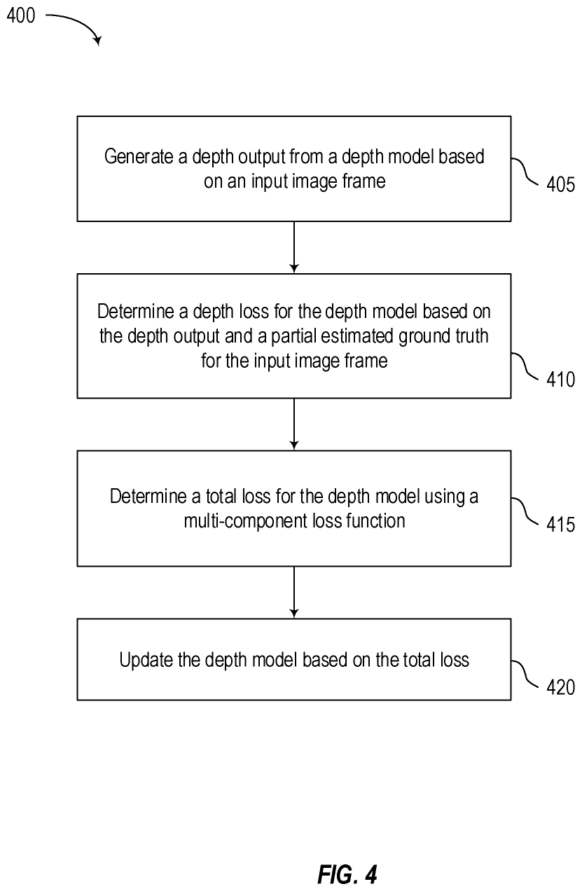

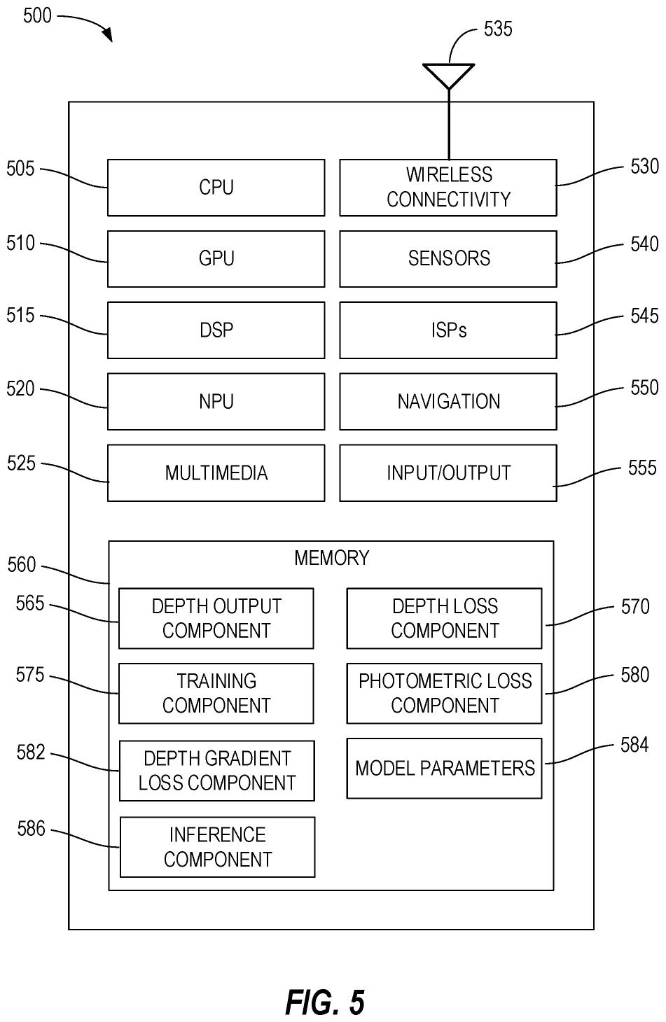

FIG. 4 depicts an example of a method 400 for using partial supervision in self-supervised monocular depth estimation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. In some aspects, a processing system 500 of FIG. 5 may perform the method 400.

At step 405, the system generates a depth output from a depth model (e.g., depth model 204 in FIG. 2) based on an input image frame (e.g., subject frame 202 in FIG. 2). In some cases, the operations of this step refer to, or may be performed by, a depth output component as described with reference to FIG. 5.

In some aspects, the depth output comprises predicted depths for a plurality of pixels of the input image frame. In some aspects, the depth output comprises predicted disparities for a plurality of pixels of the input image frame.

At step 410, the system determines a depth loss (e.g., by depth supervision loss function 212 of FIG. 2). for the depth model based on the depth output and a partial estimated ground truth for the input image frame (e.g., as provided by depth ground truth estimate function 210 of FIG. 2), the partial estimated ground truth including estimated depths for only a subset of a set of pixels of the input image frame. In some cases, the operations of this step refer to, or may be performed by, a depth loss component as described with reference to FIG. 5.

In some aspects, at step 410, the system determines the depth loss for the depth model based on the depth output and an estimated ground truth for the input image frame, the estimated ground truth comprising estimated depths for a set of pixels of the input image frame. In some aspects, the estimated ground truth for the input image frame is a partial estimated ground truth comprising estimated depths for only the set of pixels, from a plurality of pixels of the input image frame, wherein the plurality of pixels comprises at least one pixel not included in the set of pixels.

In some aspects, method 400 further includes determining the partial estimated ground truth for the input image using one or more sensors. In some aspects, the one or more sensors comprise one or more of: a camera sensor, a LIDAR sensor, or a radar sensor. In some aspects, the partial ground truth for the input image is defined by a bounding polygon defining the subset of the plurality of pixels in the input image (e.g., the bounding polygon 302 in FIG. 3). In some aspects, the partial ground truth comprises a same estimated depth for each pixel of the subset of the plurality of pixels of the input image. In some aspects, the same estimated depth is based on a central pixel of the bounding polygon (e.g., as indicated by the crosshair at point 308 in FIG. 3).

In some aspects, method 400 further includes determining the estimated depths for the subset of the plurality of pixels of the input image based on a model of an object in the input image frame within the bounding polygon, wherein the partial ground truth comprises different depths for different pixels of the subset of the plurality of pixels of the input image.

In some aspects, method 400 further includes applying a mask to the depth loss to scale the depth loss, such a mask provided by explainability mask function 214 of FIG. 2).

At step 415, the system determines a total loss for the depth model using a multi-component loss function (e.g., final loss function 205 in FIG. 2), where at least one component of the multi-component loss function is the depth loss. In some cases, the operations of this step refer to, or may be performed by, a training component as described with reference to FIG. 5.

In some aspects, at step 415, the system determines the total loss for the depth model based at least in part on the depth loss.

In some aspects, method 400 further includes determining a depth gradient loss for the depth model based on the depth output (e.g., by depth gradient loss function 208 of FIG. 2), wherein the depth gradient loss is another component of the multi-component loss function (e.g., final loss function 205 in FIG. 2).

In some aspects, method 400 further includes generating an estimated image frame (e.g., reconstructed subject frame 222 in FIG. 2) based on the depth output, one or more context frames (e.g., context frames 216 in FIG. 2), and a pose estimate (e.g., as produced by pose estimation function 220 in FIG. 2); and determining a photometric loss (e.g., as produced by photometric loss function 224 in FIG. 2) for the depth model based on the estimated image frame and the input image frame, wherein the photometric loss is another component of the multi-component loss function (e.g., final loss function 205 in FIG. 2).

In some aspects, the generating the estimate image frame comprises interpolating the estimated image frame based on the one or more context frames (e.g., context frames 216 in FIG. 2). In some aspects, the interpolation comprises bilinear interpolation. In some aspects, method 400 further includes generating the pose estimate with a pose model, separate from the depth model.

At step 420, the system updates the depth model based on the total loss. In some cases, the operations of this step refer to, or may be performed by, a training component as described with reference to FIG. 5.

In some aspects, the depth model comprises a neural network model. In some aspects, the updating of the depth model based on the total loss comprises preforming gradient descent on one or more parameters of the depth model, such as model parameters 584 of FIG. 5.

In some aspects, the method 400 further includes outputting a new depth output generated using the updated depth mode.

In some aspects, the method 400 further includes generating a runtime depth output by processing a runtime input image frame using the depth model, outputting the runtime depth output, and in response to determining that one or more triggering criteria are satisfied, refining the depth model, comprising: determining a runtime depth loss for the depth model based on the runtime depth output and a runtime estimated ground truth for the runtime input image frame, the runtime estimated ground truth comprising estimated depths for a set of pixels of the runtime input image frame, determining a runtime total loss for the depth model based at least in part on the runtime depth loss, and updating the depth model based on the runtime total loss.

In some aspects, the one or more triggering criteria comprise at least one of: a predetermined schedule for retraining; performance deterioration of the depth model; or availability of computing resources.

### Example Processing System

FIG. 5 depicts an example of processing system 500 that includes various components operable, configured, or adapted to perform operations for the techniques disclosed herein, such as the operations depicted and described with respect to FIG. 2 and/or FIG. 4.

Processing system 500 includes a central processing unit (CPU) 505, which in some examples may be a multi-core CPU 505. Instructions executed at the CPU 505 may be loaded, for example, from a program memory 560 associated with the CPU 505 or may be loaded from memory 560 partition.

Processing system 500 also includes additional processing components tailored to specific functions, such as a graphics processing unit (GPU) 510, a digital signal processor (DSP) 515, a neural processing unit (NPU) 520, a multimedia processing unit 525, and a wireless connectivity 530 component.

An NPU 520, such as, is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU 520 may sometimes alternatively be referred to as a neural signal processor (NSP), a tensor processing unit (TPU), a neural network processor (NNP), an intelligence processing unit (IPU), or a vision processing unit (VPU).

NPUs 520, such as, may be configured to accelerate the performance of common machine learning tasks, such as image classification, machine translation, object detection, and various other tasks. In some examples, a plurality of NPUs 520 may be instantiated on a single chip, such as a system on a chip (SoC), while in other examples they may be part of a dedicated machine learning accelerator device.

NPUs 520 may be optimized for training or inference, or in some cases configured to balance performance between both. For NPUs 520 that are capable of performing both training and inference, the two tasks may still generally be performed independently.

NPUs 520 designed to accelerate training are generally configured to accelerate the optimization of new models, which is a highly compute-intensive operation that involves inputting an existing dataset (often labeled or tagged), iterating over the dataset, and then adjusting model parameters 584, such as weights and biases, in order to improve model performance. Generally, optimizing based on a wrong prediction involves propagating back through the layers of the model and determining gradients to reduce the prediction error.

NPUs 520 designed to accelerate inference are generally configured to operate on complete models. Such NPUs 520 may thus be configured to input a new piece of data and rapidly process it through an already trained model to generate a model output (e.g., an inference).

In some aspects, NPU 520 may be implemented as a part of one or more of CPU 505, GPU 510, and/or DSP 515.

NPU 520 is a microprocessor that specializes in the acceleration of machine learning algorithms. For example, an NPU 520 may operate on predictive models such as artificial neural networks (ANNs) or random forests (RFs). In some cases, an NPU 520 is designed in a way that makes it unsuitable for general purpose computing such as that performed by CPU 505. Additionally or alternatively, the software support for an NPU 520 may not be developed for general purpose computing.

An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted. During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

The term “loss function” refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

In some aspects, wireless connectivity 530 component may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity 530 processing component is further connected to one or more antennas 535.

Processing system 500 may also include one or more sensor processing units associated with any manner of sensor, one or more image signal processors (ISPs 545) associated with any manner of image sensor, and/or a navigation 550 processor, which may include satellite-based positioning system components (e.g., GPS or GLONASS) as well as inertial positioning system components.

Processing system 500 may also include one or more input and/or output devices, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 560, which is representative of one or more static and/or dynamic memories, such as a dynamic random access memory 560, a flash-based static memory 560, and the like. In this example, memory 560 includes computer-executable components, which may be executed by one or more of the aforementioned components of processing system 500.

Examples of memory 560 include random access memory (RAM), read-only memory (ROM), or a hard disk. Examples of memory 560 include solid state memory and a hard disk drive. In some examples, memory 560 is used to store computer-readable, computer-executable software including instructions that, when executed, cause a processor to perform various functions described herein. In some cases, memory 560 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 560 store information in the form of a logical state.

In particular, in this example, memory 560 includes model parameters 584 (e.g., weights, biases, and other machine learning model parameters). One or more of the depicted components, as well as others not depicted, may be configured to perform various aspects of the methods described herein.

Generally, processing system 500 and/or components thereof may be configured to perform the methods described herein.

Notably, in other aspects, aspects of processing system 500 may be omitted, such as where processing system 500 is a server computer or the like. For example, multimedia processing unit 525, wireless connectivity 530, sensors 540, ISPs 545, and/or navigation 550 component may be omitted in other aspects. Further, aspects of processing system 500 may be distributed.

Note that FIG. 5 is just one example, and in other examples, alternative processing system 500 with more, fewer, and/or different components may be used.

In one aspect, processing system 500 includes CPU 505, GPU 510, DSP 515, NPU 520, multimedia processing unit 525, wireless connectivity 530, antennas 535, sensors 540, ISPs 545, navigation 550, input/output 555, and memory 560.

In some aspects, sensors 540 may include optical instruments (e.g., an image sensor, camera, etc.) for recording or capturing images, which may be stored locally, transmitted to another location, etc. For example, an image sensor may capture visual information using one or more photosensitive elements that may be tuned for sensitivity to a visible spectrum of electromagnetic radiation. The resolution of such visual information may be measured in pixels, where each pixel may relate an independent piece of captured information. In some cases, each pixel may thus correspond to one component of, for example, a two-dimensional (2D) Fourier transform of an image. Computation methods may use pixel information to reconstruct images captured by the device. In a camera, an image sensors may convert light incident on a camera lens into an analog or digital signal. An electronic device may then display an image on a display panel based on the digital signal. Image sensors are commonly mounted on electronics such as smartphones, tablet personal computers (PCs), laptop PCs, and wearable devices.

In some aspects, sensors 540 may include direct depth sensing sensors, such as radar, LIDAR, and other depth sensing sensors, as described herein.

An input/output 555 (e.g., an I/O controller) may manage input and output signals for a device. Input/output 555 may also manage peripherals not integrated into a device. In some cases, input/output 555 may represent a physical connection or port to an external peripheral. In some cases, input/output 555 may utilize an operating system. In other cases, input/output 555 may represent or interact with a modem, a keyboard, a mouse, a touchscreen, or a similar device. In some cases, input/output 555 may be implemented as part of a processor (e.g., CPU 505). In some cases, a user may interact with a device via input/output 555 or via hardware components controlled by input/output 555.

In one aspect, memory 560 includes depth output component 565, depth loss component 570, training component 575, photometric loss component 580, depth gradient loss component 582, model parameters 584, and inference component 586.

According to some aspects, depth output component 565 generates a depth output (e.g., depth output 206 of FIG. 2) using a depth model (e.g., depth model 204 of FIG. 2) based on an input image frame (e.g., subject frame 202 of FIG. 2). In some examples, the depth output includes predicted depths for a set of pixels of the input image frame. In some examples, the depth output includes predicted disparities for a set of pixels of the input image frame.

According to some aspects, depth loss component 570 (which may correspond to depth supervision loss function 212 of FIG. 2) determines a depth loss for the depth model based on the depth output and a partial estimated ground truth for the input image frame (e.g., as provided by depth ground truth estimate function 210 of FIG. 2), the partial estimated ground truth including estimated depths for only a subset of a set of pixels of the input image frame. In some examples, depth loss component 570 determines the partial estimated ground truth for the input image using one or more sensors 540. In some examples, the one or more sensors 540 include on or more of: a camera sensor, a LIDAR sensor, or a radar sensor.

In some examples, the partial ground truth for the input image is defined by a bounding polygon defining the subset of the set of pixels in the input image. In some examples, the partial ground truth includes a same estimated depth for each pixel of the subset of the set of pixels of the input image. In some examples, the same estimated depth is based on a central pixel of the bounding polygon.

In some examples, depth loss component 570 determines the estimated depths for the subset of the set of pixels of the input image based on a model of an object in the input image frame within the bounding polygon, where the partial ground truth includes different depths for different pixels of the subset of the set of pixels of the input image. In some examples, depth loss component 570 applies a mask to the depth loss to scale the depth loss (e.g., using mask operation 215 of FIG. 2).

According to some aspects, training component 575 determines a total loss for the depth model using a multi-component loss function (e.g., final loss function 205 of FIG. 2), where at least one component of the multi-component loss function is the depth loss. In some examples, training component 575 updates the depth model based on the total loss. In some examples, the depth model includes a neural network model. In some examples, the updating of the depth model based on the total loss includes preforming gradient descent on one or more parameters of the depth model.

In some examples, depth gradient loss component 582 (which may correspond to the depth gradient loss function 208 of FIG. 2) determines a depth gradient loss for the depth model based on the depth output, where the depth gradient loss is another component of the multi-component loss function.

According to some aspects, photometric loss component 580 (which may correspond to the view synthesis function 218 of FIG. 2, and/or the photometric loss function 224 of FIG. 2) generates an estimated image frame based on the depth output, one or more context frames (e.g., context frames 216 of FIG. 2), and a pose estimate (e.g., generated by pose estimation function 220 of FIG. 2). In some examples, photometric loss component 580 determines a photometric loss for the depth model based on the estimated image frame and the input image frame, where the photometric loss is another component of the multi-component loss function. In some examples, the generating the estimate image frame includes interpolating the estimated image frame based on the one or more context frames. In some examples, the interpolation includes bilinear interpolation. In some examples, photometric loss component 580 generates the pose estimate with a pose model, separate from the depth model.

According to some aspects, inference component 586 generates inferences, such as depth output based on input image data. In some examples, inference component 586 may perform depth inferencing with a model trained using training architecture 200 described above with reference to FIG. 2, and/or a model trained according to method 400 described above with respect to FIG. 4.

Notably, FIG. 5 is just one example, and many other examples and configurations of processing system 500 are possible

### Example Clauses

Implementation examples are described in the following numbered clauses:

Clause 1. A method comprising: generating a depth output from a depth model based on an input image frame, determining a depth loss for the depth model based on the depth output and a partial estimated ground truth for the input image frame, the partial estimated ground truth comprising estimated depths for only a subset of a plurality of pixels of the input image frame, determining a total loss for the depth model using a multi-component loss function, wherein at least one component of the multi-component loss function is the depth loss, and updating the depth model based on the total loss.

Clause 2. The method of Clause 1, further comprising determining the partial estimated ground truth for the input image frame using one or more sensors.

Clause 3. The method of Clause 2, wherein the one or more sensors comprise on or more of a camera sensor, a LIDAR sensor, or a radar sensor.

Clause 4. The method of Clause 2 or 3, wherein the partial estimated ground truth for the input image frame is defined by a bounding polygon defining the subset of the plurality of pixels in the input image frame.

Clause 5. The method of any of Clauses 2-4, wherein the partial estimated ground truth comprises a same estimated depth for each pixel of the subset of the plurality of pixels of the input image frame.

Clause 6. The method of any of Clauses 2-5, wherein the same estimated depth is based on a central pixel of the bounding polygon.

Clause 7. The method of any of Clauses 4-6, further comprising determining the estimated depths for the subset of the plurality of pixels of the input image frame based on a model of an object in the input image frame within the bounding polygon, wherein the partial estimated ground truth comprises different depths for different pixels of the subset of the plurality of pixels of the input image frame.

Clause 8. The method of any of Clauses 1-7, further comprising applying a mask to the depth loss to scale the depth loss.

Clause 9. The method of any of Clauses 1-8, further comprising determining a depth gradient loss for the depth model based on the depth output, wherein the multi-component loss function further comprises the depth gradient loss.

Clause 10. The method of any of Clauses 1-9, further comprising generating an estimated image frame based on the depth output, one or more context frames, and a pose estimate. Some examples further include determining a photometric loss for the depth model based on the estimated image frame and the input image frame, wherein the multi-component loss function further comprises the photometric loss.

Clause 11. The method Clause 10, wherein the generating the estimate image frame comprises interpolating the estimated image frame based on the one or more context frames.

Clause 12. The method Clause 11, wherein the interpolation comprises bilinear interpolation.

Clause 13. The method of any of Clauses 10-12, further comprising:
generating the pose estimate with a pose model, separate from the depth model.

Clause 14. The method of any of Clauses 1-13, wherein the depth output comprises predicted depths for a plurality of pixels of the input image frame.

Clause 15. The method of any of Clauses 1-13, wherein the depth output comprises predicted disparities for a plurality of pixels of the input image frame.

Clause 16. The method of any of Clauses 1-15, wherein the depth model comprises a neural network model.

Clause 17. The method of any of Clauses 1-16, wherein the updating of the depth model based on the total loss comprises preforming gradient descent on one or more parameters of the depth model.

Clause 18. A method for estimating depth, comprising estimating depth of a monocular image using a depth model trained according to any of Claims 1-17.

Clause 19: A method comprising: generating a depth output from a depth model based on an input image frame; determining a depth loss for the depth model based on the depth output and an estimated ground truth for the input image frame, the estimated ground truth comprising estimated depths for a set of pixels of the input image frame; determining a total loss for the depth model based at least in part on the depth loss; updating the depth model based on the total loss; and outputting a new depth output generated using the updated depth model.

Clause 20: The method of Clause 19, wherein the estimated ground truth for the input image frame is a partial estimated ground truth comprising estimated depths for only the set of pixels, from a plurality of pixels of the input image frame, and wherein the plurality of pixels comprises at least one pixel not included in the set of pixels.

Clause 21: The method of any Clause 19 or 20, further comprising determining the partial estimated ground truth for the input image frame using one or more sensors.

Clause 22: The method of any of Clauses 19-21, wherein the one or more sensors comprise one or more of: a camera sensor, a LiDAR sensor, or a radar sensor.

Clause 23: The method of any of Clauses 19-22, wherein the partial estimated ground truth for the input image frame is defined by a bounding polygon defining the set of pixels in the input image frame.

Clause 24: The method of any of Clauses 19-23, wherein the partial estimated ground truth comprises a same estimated depth for each pixel of the set of pixels of the input image frame and wherein the same estimated depth is based on a central pixel of the bounding polygon.

Clause 25: The method of any of Clauses 19-24, further comprising determining the estimated depths for the set of pixels of the input image frame based on a model of an object in the input image frame within the bounding polygon, wherein the partial estimated ground truth comprises different depths for different pixels of the set of pixels of the input image frame.

Clause 26: The method of any of Clauses 19-25, further comprising applying a mask to the depth loss to scale the depth loss.

Clause 27: The method of any of Clauses 19-26, further comprising determining a depth gradient loss for the depth model based on the depth output, wherein the total loss is determined using a multi-component loss function comprising the depth loss and the depth gradient loss.

Clause 28: The method of any of Clauses 19-27, further comprising: generating an estimated image frame based on the depth output, one or more context frames, and a pose estimate; and determining a photometric loss for the depth model based on the estimated image frame and the input image frame, wherein the total loss is determined using a multi-component loss function comprising the depth loss and the photometric loss.

Clause 29: The method of any of Clauses 19-28, wherein generating the estimated image frame comprises interpolating the estimated image frame based on the one or more context frames, wherein the interpolation comprises bilinear interpolation.

Clause 30: The method of any of Clauses 19-29, further comprising generating the pose estimate with a pose model, separate from the depth model.

Clause 31: The method of any of Clauses 19-30, wherein the depth output comprises predicted depths for a plurality of pixels of the input image frame.

Clause 32: The method of any of Clauses 19-31, wherein the depth output comprises predicted disparities for a plurality of pixels of the input image frame.

Clause 33: The method of any of Clauses 19-32, wherein updating the depth model based on the total loss comprises preforming gradient descent on one or more parameters of the depth model.

Clause 34: The method of any of Clauses 19-33, further comprising: generating a runtime depth output by processing a runtime input image frame using the depth model; outputting the runtime depth output; and in response to determining that one or more triggering criteria are satisfied, refining the depth model, comprising: determining a runtime depth loss for the depth model based on the runtime depth output and a runtime estimated ground truth for the runtime input image frame, the runtime estimated ground truth comprising estimated depths for a set of pixels of the runtime input image frame; determining a runtime total loss for the depth model based at least in part on the runtime depth loss; and updating the depth model based on the runtime total loss.

Clause 35: The method of any of Clauses 19-34, wherein the one or more triggering criteria comprise at least one of: a predetermined schedule for retraining, performance deterioration of the depth model, or availability of computing resources.

Clause 36: A processing system, comprising means for performing a method in accordance with any of Clauses 1-35.

Clause 37: A non-transitory computer-readable medium comprising computer-executable instructions that, when executed by one or more processors of a processing system, cause the processing system to perform a method in accordance with any of Clauses 1-35.

Clause 38: A computer program product embodied on a computer-readable storage medium comprising code for performing a method in accordance with any of Clauses 1-35.

Clause 39: A processing system comprising: a memory comprising computer-executable instructions; and one or more processors configured to execute the computer-executable instructions and cause the processing system to perform a method in accordance with any of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
generating a depth output from a depth model based on an input image frame;
determining a depth loss for the depth model based on the depth output and an estimated ground truth for the input image frame, the estimated ground truth comprising estimated depths for a set of pixels of the input image frame;
determining a total loss for the depth model based at least in part on the depth loss;
updating the depth model based on the total loss; and
outputting a new depth output generated using the updated depth model.

2. The processor-implemented method of claim 1, wherein the estimated ground truth for the input image frame is a partial estimated ground truth comprising estimated depths for only the set of pixels, from a plurality of pixels of the input image frame, wherein the plurality of pixels comprises at least one pixel not included in the set of pixels.

3. The processor-implemented method of claim 2, further comprising determining the partial estimated ground truth for the input image frame using one or more sensors.

4. The processor-implemented method of claim 3, wherein the one or more sensors comprise one or more of: a camera sensor, a LiDAR sensor, or a radar sensor.

5. The processor-implemented method of claim 3, wherein the partial estimated ground truth for the input image frame is defined by a bounding polygon defining the set of pixels in the input image frame.

6. The processor-implemented method of claim 5, wherein the partial estimated ground truth comprises a same estimated depth for each pixel of the set of pixels of the input image frame and wherein the same estimated depth is based on a central pixel of the bounding polygon.

7. The processor-implemented method of claim 5, further comprising:
determining the estimated depths for the set of pixels of the input image frame based on a model of an object in the input image frame within the bounding polygon,
wherein the partial estimated ground truth comprises different depths for different pixels of the set of pixels of the input image frame.

8. The processor-implemented method of claim 1, further comprising applying a mask to the depth loss to scale the depth loss.

9. The processor-implemented method of claim 1, further comprising:
determining a depth gradient loss for the depth model based on the depth output,
wherein the total loss is determined using a multi-component loss function comprising the depth loss and the depth gradient loss.

10. The processor-implemented method of claim 1, further comprising:
generating an estimated image frame based on the depth output, one or more context frames, and a pose estimate; and
determining a photometric loss for the depth model based on the estimated image frame and the input image frame,
wherein the total loss is determined using a multi-component loss function comprising the depth loss and the photometric loss.

11. The processor-implemented method of claim 10, wherein generating the estimated image frame comprises interpolating the estimated image frame based on the one or more context frames and wherein the interpolation comprises bilinear interpolation.

12. The processor-implemented method of claim 10, further comprising generating the pose estimate with a pose model, separate from the depth model.

13. The processor-implemented method of claim 1, wherein the depth output comprises predicted depths for a plurality of pixels of the input image frame.

14. The processor-implemented method of claim 1, wherein the depth output comprises predicted disparities for a plurality of pixels of the input image frame.

15. The processor-implemented method of claim 1, wherein updating the depth model based on the total loss comprises preforming gradient descent on one or more parameters of the depth model.

16. The processor-implemented method of claim 1, further comprising:
generating a runtime depth output by processing a runtime input image frame using the depth model;
outputting the runtime depth output; and
in response to determining that one or more triggering criteria are satisfied, refining the depth model, comprising:
determining a runtime depth loss for the depth model based on the runtime depth output and a runtime estimated ground truth for the runtime input image frame, the runtime estimated ground truth comprising estimated depths for a set of pixels of the runtime input image frame;
determining a runtime total loss for the depth model based at least in part on the runtime depth loss; and
updating the depth model based on the runtime total loss.

17. The processor-implemented method of claim 16, wherein the one or more triggering criteria comprise at least one of:
a predetermined schedule for retraining;
performance deterioration of the depth model; or
availability of computing resources.

18. A processing system, comprising:
a memory comprising computer-executable instructions; and
one or more processors configured to execute the computer-executable instructions and cause the processing system to perform an operation, comprising:
generating a depth output from a depth model based on an input image frame;
determining a depth loss for the depth model based on the depth output and an estimated ground truth for the input image frame, the estimated ground truth comprising estimated depths for a set of pixels of the input image frame;
determining a total loss for the depth model based at least in part on the depth loss;
updating the depth model based on the total loss; and
outputting a new depth output generated using the updated depth model.

19. The processing system of claim 18, wherein the estimated ground truth for the input image frame is a partial estimated ground truth comprising estimated depths for only the set of pixels, from a plurality of pixels of the input image frame, and wherein the plurality of pixels comprises at least one pixel not included in the set of pixels, the operation further comprising determining the partial estimated ground truth for the input image frame using one or more sensors.

20. The processing system of claim 19, the operation further comprising:
determining the estimated depths for the set of pixels of the input image frame based on a model of an object in the input image frame,
wherein the partial estimated ground truth comprises different depths for different pixels of the set of pixels of the input image frame.

21. The processing system of claim 18, the operation further comprising:
determining a depth gradient loss for the depth model based on the depth output,
wherein the total loss is determined using a multi-component loss function comprising the depth loss and the depth gradient loss.

22. The processing system of claim 18, the operation further comprising:
generating an estimated image frame based on the depth output, one or more context frames, and a pose estimate; and
determining a photometric loss for the depth model based on the estimated image frame and the input image frame,
wherein the total loss is determined using a multi-component loss function comprising the depth loss and the photometric loss.

23. The processing system of claim 18, the operation further comprising:
generating a runtime depth output by processing a runtime input image frame using the depth model;
outputting the runtime depth output; and
in response to determining that one or more triggering criteria are satisfied, refining the depth model, comprising:
determining a runtime depth loss for the depth model based on the runtime depth output and a runtime estimated ground truth for the runtime input image frame, the runtime estimated ground truth comprising estimated depths for a set of pixels of the runtime input image frame;
determining a runtime total loss for the depth model based at least in part on the runtime depth loss; and
updating the depth model based on the runtime total loss.

24. A non-transitory computer-readable medium comprising computer-executable instructions that, when executed by one or more processors of a processing system, cause the processing system to perform an operation comprising:
generating a depth output from a depth model based on an input image frame;
determining a depth loss for the depth model based on the depth output and an estimated ground truth for the input image frame, the estimated ground truth comprising estimated depths for a set of pixels of the input image frame;
determining a total loss for the depth model based at least in part on the depth loss;
updating the depth model based on the total loss; and
outputting a new depth output generated using the updated depth model.

25. The non-transitory computer-readable medium of claim 24, wherein the estimated ground truth for the input image frame is a partial estimated ground truth comprising estimated depths for only the set of pixels, from a plurality of pixels of the input image frame, and wherein the plurality of pixels comprises at least one pixel not included in the set of pixels, the operation further comprising determining the partial estimated ground truth for the input image frame using one or more sensors.

26. The non-transitory computer-readable medium of claim 25, the operation further comprising:
determining the estimated depths for the set of pixels of the input image frame based on a model of an object in the input image frame,
wherein the partial estimated ground truth comprises different depths for different pixels of the set of pixels of the input image frame.

27. The non-transitory computer-readable medium of claim 24, the operation further comprising:
determining a depth gradient loss for the depth model based on the depth output,
wherein the total loss is determined using a multi-component loss function comprising the depth loss and the depth gradient loss.

28. The non-transitory computer-readable medium of claim 24, the operation further comprising:
generating an estimated image frame based on the depth output, one or more context frames, and a pose estimate; and
determining a photometric loss for the depth model based on the estimated image frame and the input image frame,
wherein the total loss is determined using a multi-component loss function comprising the depth loss and the photometric loss.

29. The non-transitory computer-readable medium of claim 24, the operation further comprising:
generating a runtime depth output by processing a runtime input image frame using the depth model;
outputting the runtime depth output; and
in response to determining that one or more triggering criteria are satisfied, refining the depth model, comprising:
determining a runtime depth loss for the depth model based on the runtime depth output and a runtime estimated ground truth for the runtime input image frame, the runtime estimated ground truth comprising estimated depths for a set of pixels of the runtime input image frame;
determining a runtime total loss for the depth model based at least in part on the runtime depth loss; and
updating the depth model based on the runtime total loss.

30. A processing system, comprising:
means for generating a depth output from a depth model based on an input image frame;
means for determining a depth loss for the depth model based on the depth output and a partial estimated ground truth for the input image frame, the partial estimated ground truth comprising estimated depths for only a subset of a plurality of pixels of the input image frame;
means for determining a total loss for the depth model using a multi-component loss function, wherein at least one component of the multi-component loss function is the depth loss; and
means for updating the depth model based on the total loss.
